(19) United States
(12) Patent Application Publication
(10) Pub. No.: US 2008/0161076 A1
(43) Pub. Date: Jul. 3, 2008

(54) CASE FOR COMMUNICATION TERMINAL AND COMMUNICATION TERMINAL USING THE SAME

(75) Inventors: Kyung Ho MIN, Seoul (KR); Chae Ho Na, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/960,475

(22) Filed: Dec. 19, 2007

(30) Foreign Application Priority Data
Dec. 20, 2006 (KR) 10-2006-0131076
Dec. 20, 2006 (KR) 10-2006-0131085

(51) Int. Cl. H04M 1/00

(52) U.S. Cl. 455/575.7; 455/575.1

(57) ABSTRACT

A case for a communication terminal and a communication terminal using the case are provided. The case includes a coupling unit configured to electrically couple the communication terminal and the case, and an extension device formed in the case and configured to extend a communication performance of the communication terminal when the communication terminal and the case are coupled together via the coupling unit.

This application claims priority under 35 U.S.C. §119(a) on Patent Application No. 10-2006-0131076 and 10-2006-0131085, filed in Republic of Korea on Dec. 20, 2006 the entire contents of which are hereby incorporated by reference.

### BACKGROUND

1. Field

This document relates to a case for a communication terminal, and a communication terminal using the case.

2. Related Art

In a communication terminal, a case made of a material such as plastic is detachably provided. The case is fastened to the communication terminal to be used as a means for protecting a housing of the communication terminal from the outside.

However, when the case is fastened to the communication terminal, due to a dielectric substance and other metal materials, etc. constituting the case, frequency characteristics of the communication terminal change. Thereby, a performance of an antenna provided in the communication terminal may be deteriorated.

Further, as many functions are added to the communication terminal, it is difficult to extend a function of the communication terminal while decreasing a size of the communication terminal.

### SUMMARY

An aspect of this document is to provide a case for a communication terminal and a communication terminal using the case that can extend a communication performance of a communication terminal by coupling a case for the communication terminal comprising an extension device for extending the communication performance and the communication performance.

Another aspect of this document is to provide a case for a communication terminal and a communication terminal using the case that can extend a performance of the communication terminal while decreasing a size of the communication terminal by forming an extension device for extending a communication performance of the communication terminal in the case for the communication terminal.

In one general aspect, a case for a communication terminal comprises a coupling unit configured to electrically couple the communication terminal and the case, and an extension device formed in the case and configured to extend a communication performance of the communication terminal when the communication terminal and the case are coupled together via the coupling unit.

The extension device may comprise an operating antenna having a specific frequency band and that is connected to a Radio Frequency (RF) module in the communication terminal when the communication terminal and the case are coupled together via the coupling unit.

The extension device may comprise an operating power amplifier configured to amplify a transmission output of the communication terminal that is connected to a Radio Frequency (RF) module in the communication terminal when the communication terminal and the case are coupled together via the coupling unit.

In another aspect, a communication terminal, comprises a communication module configured to wirelessly communicate with at least one other terminal, a case configured to cover at least a portion of the communication terminal, a coupling unit configured to electrically couple the communication terminal and the case, and an extension device formed in the case and configured to extend a communication performance of the communication terminal when the communication terminal and the case are coupled together via the coupling unit.

The coupling unit may comprise a first connector formed in the case, and a second connector formed in the communication terminal configured to electrically connect to the first connector when the communication terminal and the case are coupled together.

The extension device may comprise at least one operating antenna having a specific frequency band.

In yet another aspect, a method of communicating on a mobile terminal, the method comprises coupling a case to the mobile terminal such that the case and the mobile terminal are electrically coupled together, and transmitting a signal from the mobile terminal that has been received or amplified by an extension communication device formed in the case.

The extension communication device may comprise at least one operating antenna having a specific frequency band or a power amplifier.

The method may further comprise providing a menu option allowing a user to select a class transmission power from among a plurality of class transmission powers, and amplifying a signal to be output via an internal antenna in the mobile terminal using the amplifier formed in the case to have the class transmission power selected by the user from the menu option.

### BRIEF DESCRIPTION OF THE DRAWINGS

The details of one or more implementations are set forth in the accompanying drawings and the description below. In the entire description of this document, like reference numerals represent corresponding parts throughout various figures.

FIGS. 1A and 1B are perspective views illustrating a case for a communication terminal and a communication terminal using the case in an implementation;

FIG. 2 is a perspective view illustrating an example in which an extension device is an antenna in an implementation;

FIG. 3 is a view illustrating a case in which the extension device is an antenna in FIG. 2;

FIG. 4 is a perspective view illustrating a second connector of a communication terminal connected to a first connector of the case in an implementation;

FIG. 5 is a block diagram illustrating a configuration of a communication terminal in an implementation;

FIG. 6 is a flowchart illustrating a method of using an antenna of a communication terminal in an implementation;

FIG. 7 is a diagram illustrating an operation when a case and a communication terminal are coupled in an implementation;

FIGS. 8A and 8B are diagrams illustrating an example of switching a switch in order to check whether a case is fastened;

FIG. 9 is a diagram illustrating an operation of a corresponding antenna when a specific additional function is selected in an implementation;

FIG. 10 is a diagram illustrating an example in which fastening terminals are provided in a case and a communication terminal in another implementation;

FIG. 11 is a cross-sectional view of a pogo pin in another implementation;

FIGS. 12A and 12B are views illustrating a first connector and a second connector in another implementation;

FIG. 13 is a perspective view illustrating a communication terminal using a case for a communication terminal in another implementation;

FIG. 14 is a view illustrating an example in which an extension device is a power amplifier in another implementation;

FIG. 15 is a perspective view illustrating a first input/output unit and a first interface of a communication terminal to be fastened to a case in an implementation;

FIG. 16 is a block diagram illustrating a configuration of a case for a communication terminal in an implementation;

FIG. 17 is a block diagram illustrating a configuration of a communication terminal in an implementation;

FIG. 18 is a table illustrating a class of transmission power of Bluetooth;

FIG. 19 is a flowchart illustrating a method of amplifying power of a communication terminal in an implementation;

FIG. 20 is a diagram illustrating a process of selecting a class in an implementation; and

FIG. 21 is a block diagram illustrating an operation when a case and a communication terminal are coupled in an implementation.

### DETAILED DESCRIPTION

Hereinafter, in an implementation of this document, a case for a communication terminal and a communication terminal using the case will be described in detail with reference to the accompanying drawings.

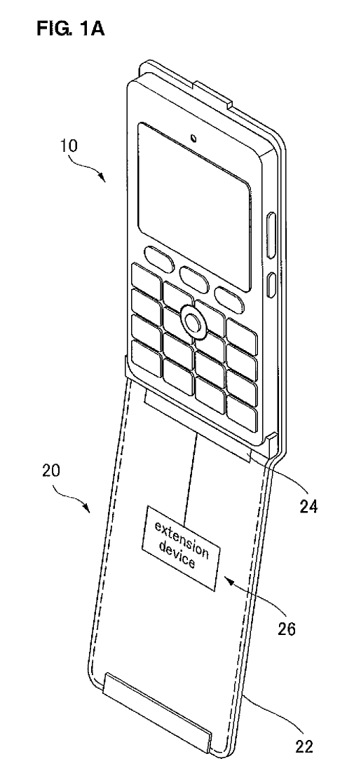

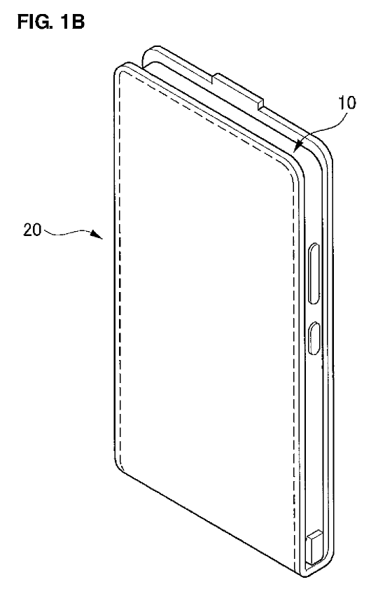

FIGS. 1A and 1B are perspective views illustrating a case for a communication terminal and a communication terminal using the case in an implementation.

As shown in FIGS. 1A and 1B, a case 20 is detachably coupled to the outside of a communication terminal 10. In the case 20, a case unit 22 for protecting a housing of the communication terminal 10 is made of a leather material.

In the case unit 22, a connector 24 and an extension device 26 are formed. When the communication terminal 10 is coupled to the connector 24, the extension device 26 extends a communication performance of the communication terminal 10.

An Implementation (When the Extension Device is an Antenna)

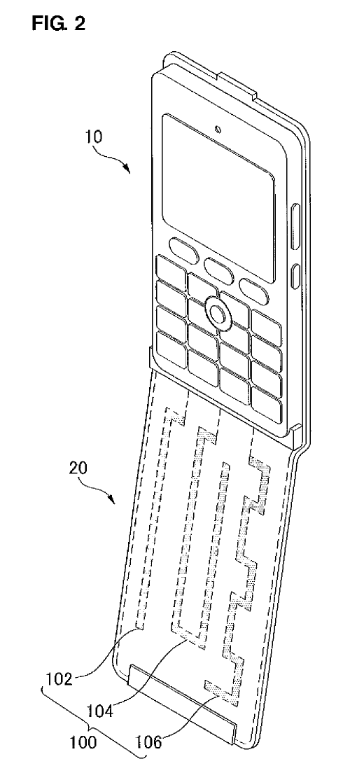

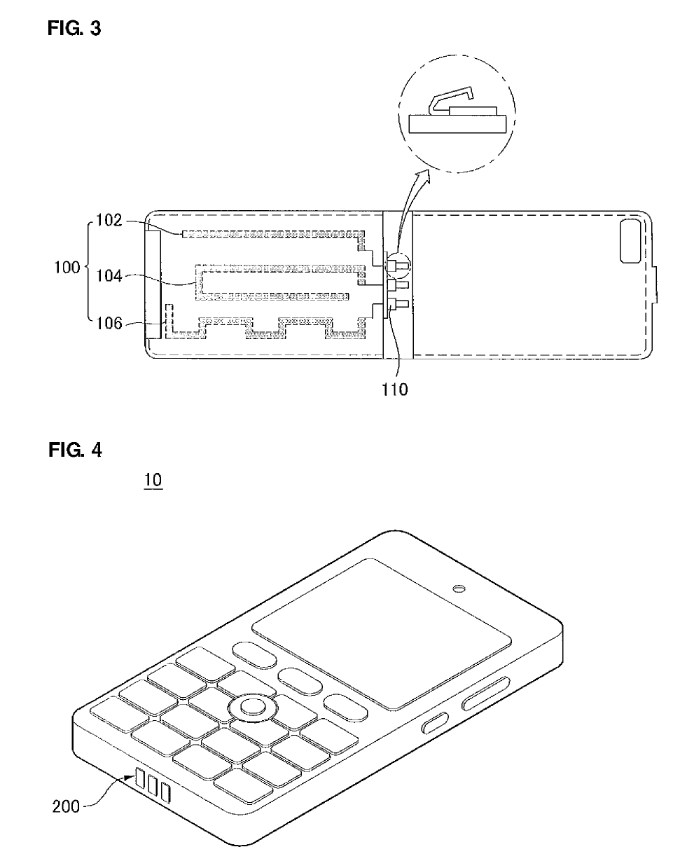

FIG. 2 is a perspective view illustrating an example in which an extension device is an antenna in an implementation. FIG. 3 is a view illustrating a case in which the extension device is an antenna in FIG. 2.

Referring in FIGS. 2 and 3, the extension device 26 may be an antenna. Accordingly, when the communication terminal 10 and the case 20 are coupled, the extension device 26 operates as an antenna having a specific frequency band. In this case, the extension device 26 operates as an external antenna 100 formed in the outside of the communication terminal 10.

The external antenna 100 comprises a first external antenna 102, a second external antenna 104, and a third external antenna 106.

Each of the external antennas 100 can be operated in several frequency bands. For example, the first external antenna 102 operates in a Bluetooth frequency band, the second external antenna 104 operates in a CDMA or GSM frequency band. Further, the third internal antenna 106 operates in a FM radio frequency. A pattern and a shape of the external antenna 100 can be designed according to a corresponding frequency band.

Further, the external antenna 100 can be formed in the inside of the case 20 and is connected to a first connector 110, which is the connector 24 protruded to the outside of the case 20.

In this case, the first connector 110 is formed in the quantity corresponding to that of the external antenna 100. That is, when the external antenna 100 is formed in a first, second, and third external antennas (102, 104, 106), the first connector 110 has also three terminals.

The first connector 110 contacts with the communication terminal 10 and has a protruded contact portion. Accordingly, when the first connector 110 is fastened to the communication terminal 10, the first connector 110 is easily coupled to the communication terminal 10 due to an elastic force corresponding to a pressure in which the communication terminal 10 applies.

The communication terminal 10 to be fastened to the first connector 110 is shown in FIG. 4.

FIG. 4 is a perspective view illustrating a second connector of a communication terminal to be connected to a first connector of the case in an implementation.

As shown in FIG. 4, the first connector 110 of the case 20 of FIG. 3 is connected to the second connector 200 formed at a lower end of the communication terminal 10. The second connector 200 is a conductive terminal and is formed in a position and the quantity corresponding to the first connector 110. For example, when the first connector 110 is formed in three protruded portions, the second connector 200 is also formed in three terminals.

Therefore, when the case 20 is fastened to communication terminal 10, the first connector 110 and the second connector 200 come in contact and are coupled.

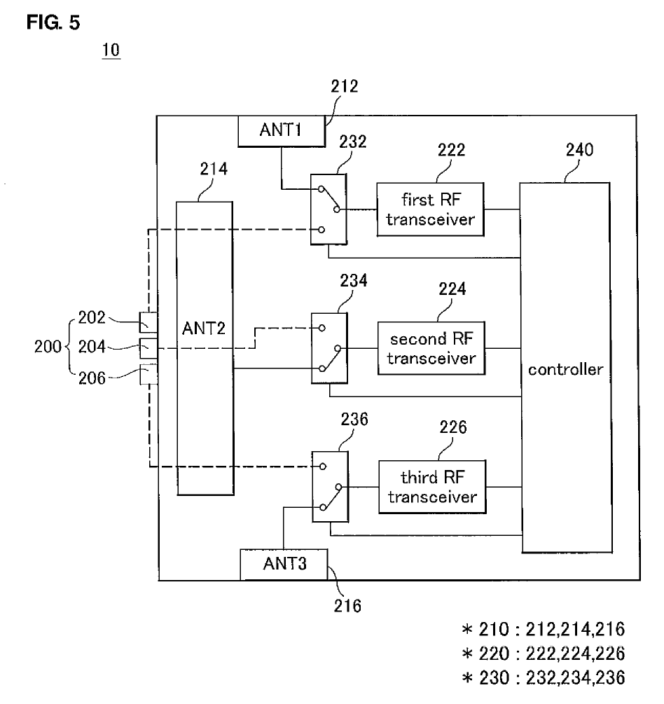

An internal configuration of the communication terminal 10 to be fastened to the case 20 is shown in FIG. 5.

FIG. 5 is a block diagram illustrating a configuration of a communication terminal in an implementation.

Referring in FIGS. 3 and 5, the communication terminal 10 comprises a second connector 200, an internal antenna 210, an RF transceiver 220, a switch 230, and a controller 240.

When the case 20 is fastened to the communication terminal 10, the second connector 200 contacts with the first connector 110.

The internal antenna 210 comprises a main antenna operating in a communication network of Code Division Multiple Access (CDMA) and Global System for Mobile Communication (GSM). Further, the internal antenna 210 comprises a sub-antenna corresponding to the external antenna 100 operating in Bluetooth and a FM radio frequency formed in the case 20.

For example, a first internal antenna 212 operates in a Bluetooth frequency band, or a second internal antenna 214 operates in a CDMA or GSM frequency band. Further, a third internal antenna 216 operates in a FM radio frequency. The internal antenna 210 may be formed in antennas of the quantity equal to or greater than that of the external antenna 100.

The RF transceiver 220 transmits, receives, and processes an RF signal corresponding to a frequency of the external antenna 100 and the internal antenna 210 by the control of the controller 240.

The switch 230 is provided between the second connector 200 and the RF transceiver 220 and connects the external antenna 100 or the internal antenna 210 to the RF transceiver 220.

The controller 240 comprises a Mobile Station Modem (MSM) and controls general input and output of the communication terminal 10. Furthers when the first connector 110 and the second connector 200 come in contact, the controller 240 controls the switch 230 so that the external antenna 100 or the internal antenna 210 is connected to the RF transceiver 220.

An operation of a case for a communication terminal and a communication terminal using the case having the above described configuration is described as follows.

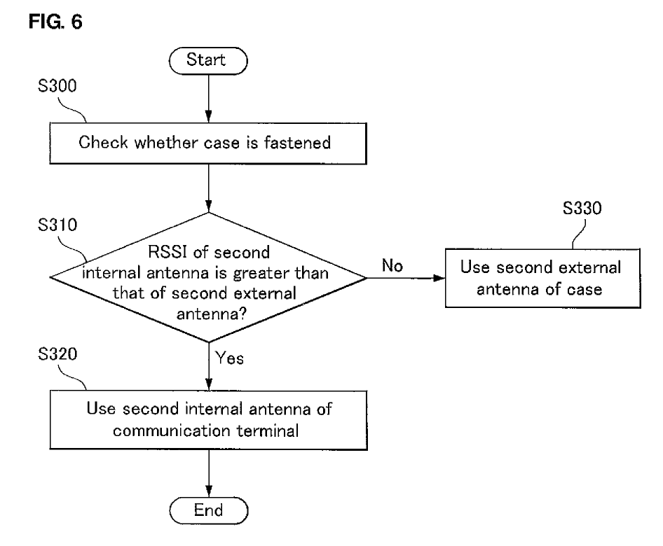

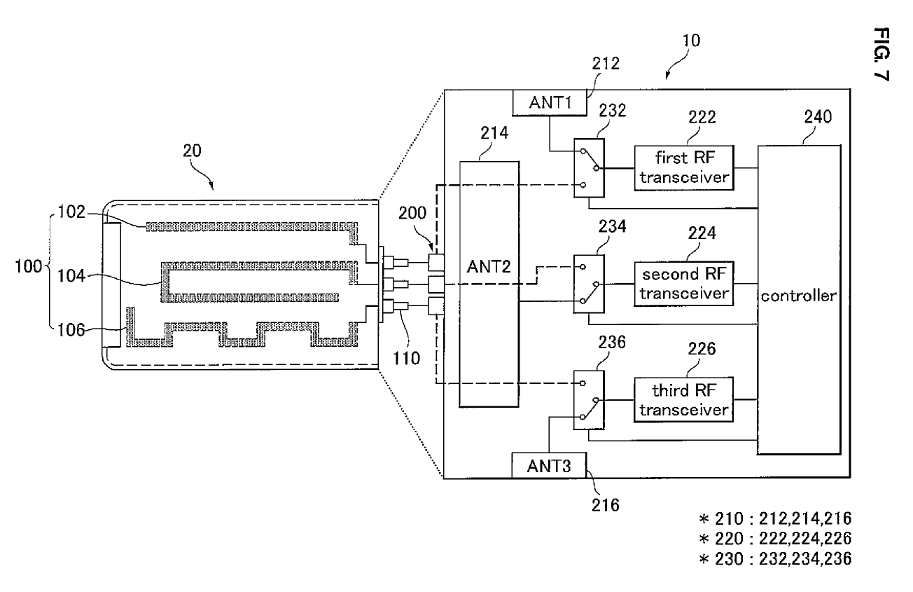

FIG. 6 is a flowchart illustrating a method of using an antenna of a communication terminal in an implementation. FIG. 7 is a diagram illustrating an operation when a case and a communication terminal are coupled in an implementation.

As shown in FIG. 6, the controller 240 checks a RSSI of the external antenna 100 by switching the switch 230 in every predetermined time while operating in a CDMA communication network using the second internal antenna 214.

The controller 240 checks whether power is received from the first connector 110 through the second connector 200 by connecting the switch 230 to the second connector 200, thereby knowing the RSSI of the external antenna 100.

in this case, when the case 20 is fastened to the communication terminal 10, the first connector 110 and the second connector 200 are connected. Accordingly, the controller 240 checks the RSSI of the second external antenna 104, thereby knowing that the case 20 is fastened to the communication terminal 10 (S300).

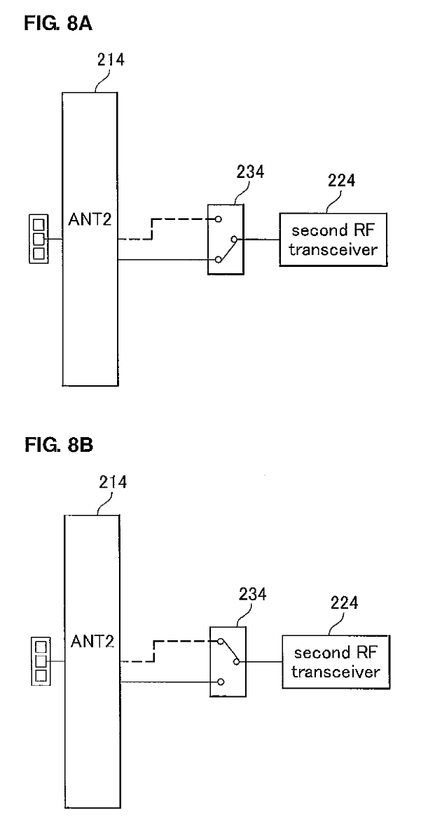

Thereafter, in order to check the RSSI of the second internal antenna 214 and the second external antenna 104, the controller 240 switches the switch, as shown in FIGS. 8A and 8B.

FIGS. 8A and 8E are diagrams illustrating an example of switching a switch in order to check whether a case is fastened.

As shown in FIG. 8A, the second switch 234 is connected to the second internal antenna 214. In this state, the controller 240 connects the second switch 234 to the second connector 204 in every predetermined time, as shown in FIG. 8B. The controller 240 switches the second switch 234, thereby knowing that the case 20 is fastened to the communication terminal 10.

Thereafter, as shown in FIGS. 8A and 8B, the controller 240 checks whether the RSSI of the second internal antenna 214 is greater than that of the second external antenna 104 by switching the second switch 234 (S310). If the RSSI of the second internal antenna 214 is greater than that of the second external antenna 104, the controller 240 connects the second switch 234 to the second internal antenna 214.

The second internal antenna 214 is connected to the second RF transceiver 224 and thus the second internal antenna 214 is used (S320).

If the RSSI of the second internal antenna 214 is not greater than that of the second external antenna 104, the controller 240 connects the second switch 234 to the second connector 204. Therefore, the second switch 234 is connected to the second external antenna 104 formed in the case 20, whereby the second external antenna 104 is connected to the second RF transceiver 224 and thus the second external antenna 104 is used (S330).

In the implementation, as the controller 240 switches the second switch 234, an antenna having a better RSSI is used, however this document is not limited thereto. That is, when it is checked that the case 20 is fastened to the communication terminal 10 by switching the second switch 234 while using the second internal antenna 214, the controller 240 controls to use the second external antenna 104 formed in the case 20.

Further, an example of operating another antenna while using the second internal antenna 214 or the second external antenna 104, which is a main antenna is described as follows.

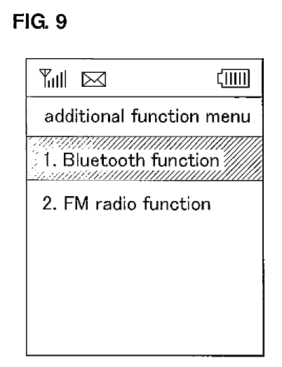

FIG. 9 is a diagram illustrating an operation of a corresponding antenna when selecting a specific additional function in an implementation.

As shown in FIG. 9, the user executes “1. Bluetooth function” among additional functions provided by the communication terminal 10. Accordingly, the controller 240 can operate one of the first internal antennas 212 and the first external antenna 102 operating in a Bluetooth frequency with the above-described principle. That is, by checking the RSSI of the first external antenna 102 by the above-described principle, the controller 240 checks whether the case 20 is fastened to the communication terminal 10.

If the case 20 is fastened to the communication terminal 10, the controller 240 compares the RSSI of the first internal antenna 212 with that of the first external antenna 102 and executes an antenna having a better RSSI.

In another example, as shown in FIG. 9, the user executes “2. FM radio function” among additional functions provided by the communication terminal 10. Accordingly, the controller 240 checks whether the case 20 is fastened to the communication terminal 10 with the above-described principle.

If the case 20 is fastened to the communication terminal 10, the controller 240 executes an antenna having a better RSSI between the third internal antenna 216 and the third external antenna 106.

In the above-described implementation, by checking the RSSI of the external antenna 100 corresponding to the internal antenna 210, it can be seen that the case 20 is fastened to the communication terminal 10, however this document is not limited thereto. That is, the controller 240 can check whether the case 20 is fastened to the communication terminal 10 by switching one of switches 230 coupled to the second connector 200.

In this case, the controller 240 checks the RSSI by switching one of the switches 230 connected to the second connector 200, thereby checking whether the case 20 and the communication terminal 10 are fastened.

Further, when the case 20 and the communication terminal 10 are fastened, a fastening signal may be output to the controller 240, and an example thereof is described as follows.

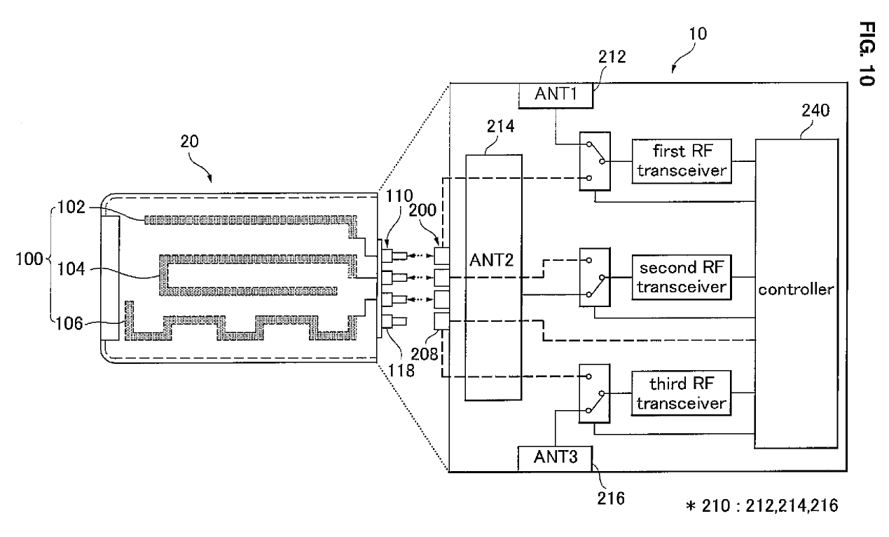

FIG. 10 is a diagram illustrating an example in which fastening terminals are provided in a case and a communication terminal in another implementation.

As shown in FIG. 10, a first fastening terminal 118 provided in one side of the first connector 110 of the case 20. Further, in order to correspond to the first fastening terminal 118, a second fastening terminal 208 is provided at one side of the second connector 200 of the communication terminal 10.

The first fastening terminal 118 and the second fastening terminal 208 are not connected to the respective external antenna 100 and internal antenna 210. However, the second fastening terminal 208 is connected to the controller 240.

In such a state, when the communication terminal 10 and the case 20 are fastened, the first fastening terminal 118 formed in the first connector 110 and the second fastening terminal 208 formed in the second connector 200 come in contact. Accordingly, because the second fastening terminal 208 outputs a fastening signal to the controller 240, the controller 20 can know that the case 240 is fastened to the communication terminal 10.

In the above-described implementation, it is described that a contact portion of the first connector 110 is protruded to contact with the second connector 200. However, the first connector 110 may be formed in a pogo pin, and an example thereof is described as follows.

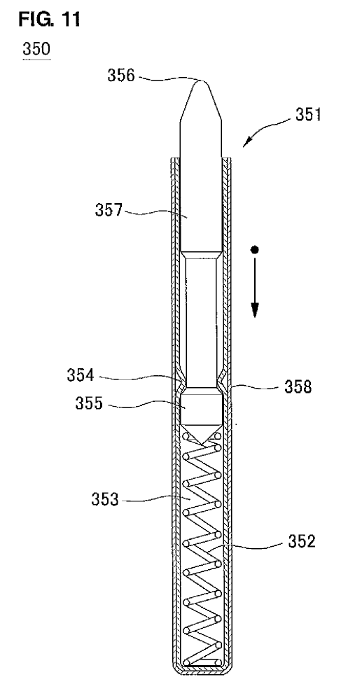

FIG. 11 is a cross-sectional view of a pogo pin in another implementation.

As shown in FIG. 11, a contact portion of the first connector 110 may use a pogo pin 350. The pogo pin 350 comprises a pin 351 and a receptacle 358 into which the pin 351 is inserted and provided. In this case, a body 357 of the pin 351 of the pogo pin 350 is formed in a cylindrical shape, and in the receptacle 358, one side thereof is opened and a sliding groove 353 is formed at the inside thereof, and a locking groove 354 depressed in a predetermined depth is formed following the sliding groove 353.

The body 357 has a locking jaw 355 locked to the locking groove 354 and has a probe 356 contacting with the second connector (200 of FIG. 4) at a tip thereof and moves in a front and rear direction or a vertical direction along the sliding groove 353. The body 357 contacts with a rear surface of the locking jaw 355 and moves in a front and rear direction or a vertical direction by an elastic force of a spring 352 inserted into and provided within the sliding groove 353.

The pogo pin 350 is formed in the first connector 110 and coupled to the second connector 200 of FIG. 4, and an example thereof is described as follows.

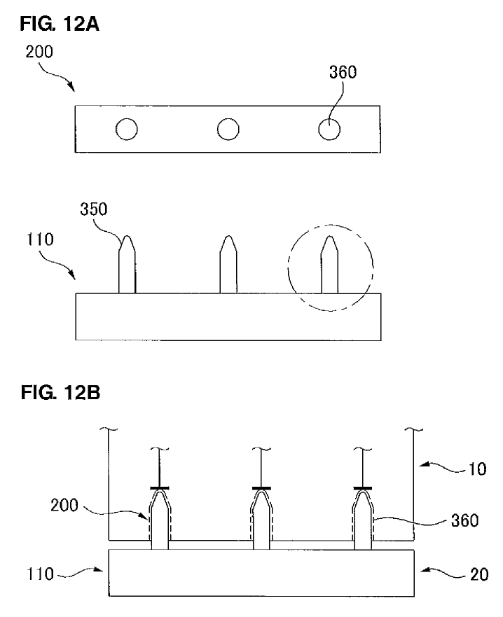

FIGS. 12A and 12B are views illustrating a first connector and a second connector in another implementation.

As shown in FIG. 12A, the first connector 110 may be formed in the pogo pin 350 of FIG. 11. Accordingly, in the second connector 200, a predetermined hole 360 is formed with the quantity and in a position corresponding to the pogo pin 350.

Therefore, as shown in FIG. 12B, when the communication terminal 10 and the case 20 are fastened, the first connector 110 of the pogo pin 350 formed in the case 20 is coupled to a hole 360 formed in the second connector 200 of the communication terminal 10, whereby the above-described operation is performed.

In addition to the pogo pin 350, various fastening structures can be used.

In the above-described implementation, three external and internal antennas (100, 210) are formed, and thus an example in which the first connector 110 and the second connector 200 have three contact portions is described.

However, this document is not limited thereto, various quantities of antennas may be formed, and thus the quantity of the contact portion of the first connector 110 and the second connector 200 can be changed. For example, when the quantity of the external and internal antennas (100, 210) is four, the first connector 110 and the second connector 200 are formed in four contact portions. In this case, as shown in FIG. 10, the fastening portion 118 may be further formed.

Further, in the above-described implementation, the case 20 is made of leather, however the case 20 is not limited thereto and may be made of several materials such as plastic.

Further, the external antenna 100 formed in the case 20 may be formed on a surface as well as the inside of the case 20 and may be formed in a Flexible Printed Circuit Board (FPCB).

Further, the external antenna 100 formed in the case 20 may be formed in several surfaces of the case 20.

Further, in the above-described implementation, when the first connector 110 and the second connector 200 come in contact, the external antenna 100 or the internal antenna 210 is selectively connected to RF transceiver 220, however this document is not limited thereto.

That is, in this document, when the communication terminal 10 and the case 20 are fastened, by extending both the external antenna 100 and the internal antenna 210, the external antenna 100 may extend a length of the internal antenna 210.

Another Implementation (when the Extension Device is a Power Amplifier)

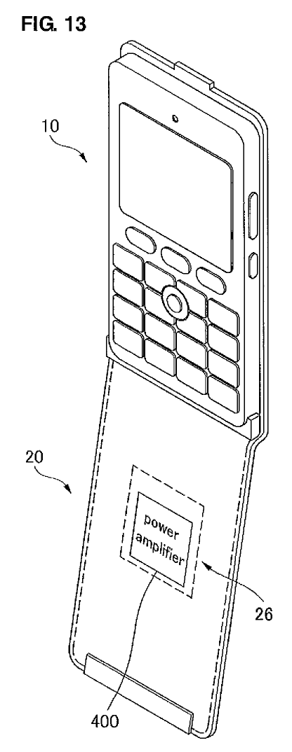

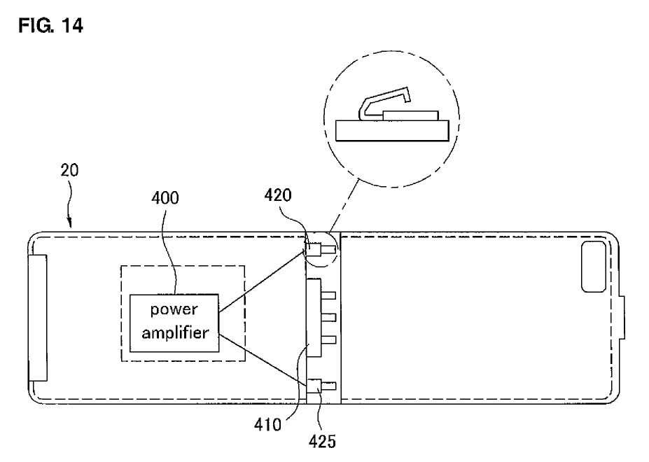

FIG. 13 is a perspective view illustrating a communication terminal using a case for a communication terminal in another implementation. FIG. 14 is a view illustrating an example in which an extension device is a power amplifier in another implementation.

As shown in FIGS. 13 and 14, the extension device 26 formed in the case 20 for the communication terminal 10 may be a power amplifier 400. Further, in one side of the case 20, a second interface 410 and second input/output units (420, 425), which are connectors, and the power amplifier 400 are formed.

The second interface 410 and the second input/output units (420, 425) contact with communication terminal 10 and a contact portion thereof is protruded. Accordingly, when the case 20 is fastened to the communication terminal 10, the case 20 is easily coupled to the communication terminal 10 due to an elastic force corresponding to a pressure to which the communication terminal 10 applies.

The communication terminal 10 fastened to the case 20 is described as follows.

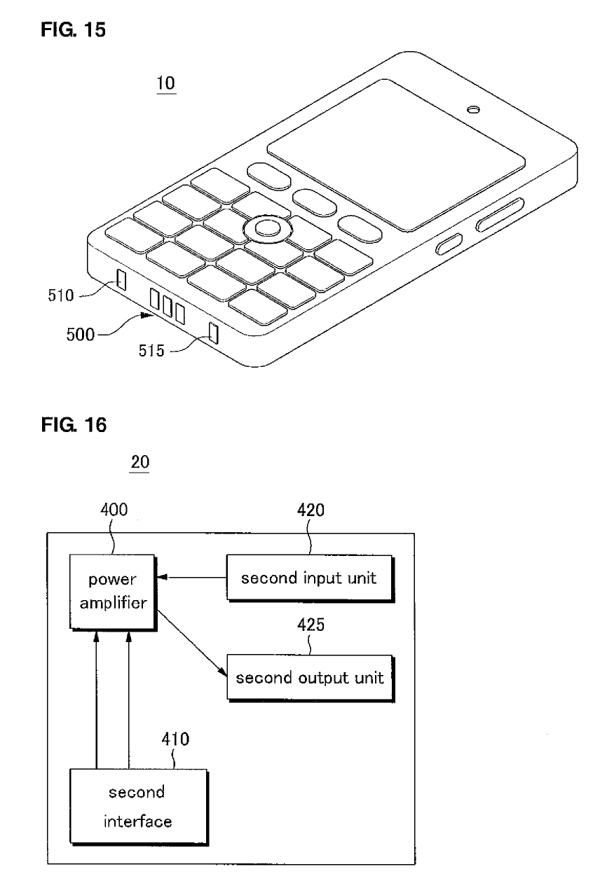

FIG. 15 is a perspective view illustrating a first input/output unit and a first interface of a communication terminal to be fastened to a case in an implementation.

Referring to FIGS. 14 and 15, a first interface 500 and first input/output units (510, 515) of the communication terminal 10 are conductive terminals. The first interface 500 and the first input/output units (510, 515) are formed in a position and with the quantity corresponding to the second interface 410 and the second input/output units (420, 425) of FIG. 14.

For example, if the first interface 500 is formed in three terminals, the second interface 410 is also formed in three protruded portions. Further, if the first input/output units (510, 515) are formed in two terminals, the second input/output units (420, 425) are also formed in two protruded portions.

Therefore, when the case 20 is fastened to the communication terminal 10, the first interface 500 and the second interface 410 come in contact with and are coupled to each other. Further, the first input/output units (510, 515) and the second input/output units (420, 425) come in contact with and are coupled to each other.

A configuration of the case 20 is described as follows.

FIG. 16 is a block diagram illustrating a configuration of the case for the communication terminal in an implementation.

As shown in FIG. 16, the second interface 410, the second input/output units (420, 425), and the power amplifier 400 are formed at one side of the case 20.

The second interface 410 receives a control signal for controlling the power amplifier 400 from the communication terminal 10, inputs the signal to the power amplifier 400, and outputs a fastening signal to the communication terminal 10 when the communication terminal 10 and the case 20 are fastened.

The second input/output units (420, 425) comprise a second input unit 420 and a second output unit 425. Therefore, a signal having the first transmission output is received from the communication terminal 10 through the second input unit 420. Further, a signal having the second transmission output is output to the communication terminal 10 through the second output unit 425.

The power amplifier 400 amplifies a signal having the first transmission output that is input through the second input unit 420 to a signal having the second transmission output and outputs the amplified signal to the second output units 425.

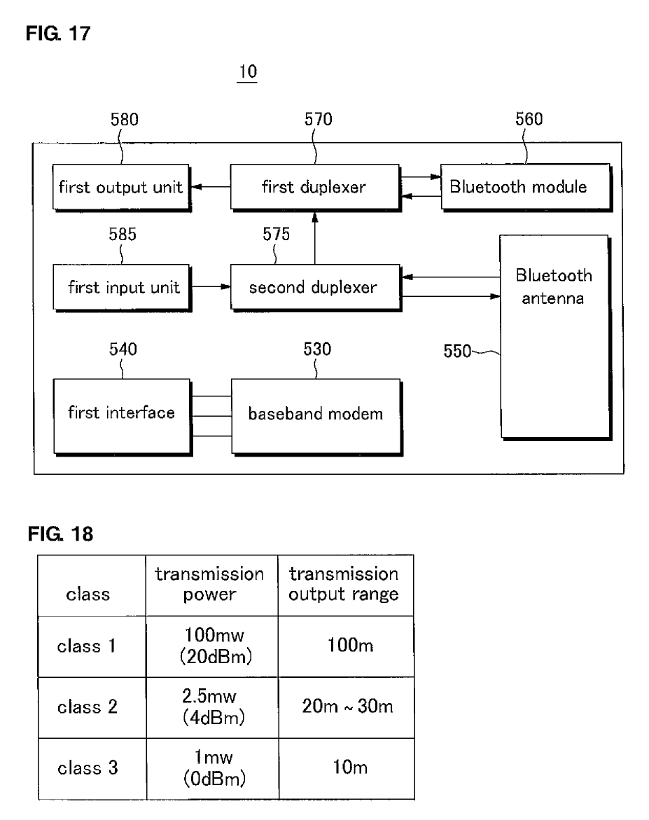

A configuration of the communication terminal 10 fastened to the case 20 is shown in FIG. 17.

FIG. 17 is a block diagram illustrating a configuration of a communication terminal in an implementation.

As shown in FIG. 17, the communication terminal 10 fastened to the case 20 comprises a baseband modem 530, a first interface 540, a Bluetooth antenna 550, a Bluetooth module 560, a first duplexer 570, a second duplexer 575, a first output unit 580, and a first input unit 585.

The baseband modem 530 is a modem unit, and processes a Bluetooth protocol of a physical hierarchy. Further, the baseband modem 530 outputs a control signal for controlling the power amplifier 400 of the case 20 of FIG. 14.

The first interface 540 outputs a control signal generating in the baseband modem 530 to the case 20.

The Bluetooth antenna 550 receives an electric wave in a Bluetooth frequency band (having a width of 83.5 MHz) of 2400 MHz to 2483.5 MHZ introduced from the outside. In this case, the Bluetooth antenna 550 can receive a signal having first transmission output and output a signal having second transmission output.

The Bluetooth module 560 comprises a circuit such as a series of chips for Bluetooth communication. Accordingly, the Bluetooth module 560 converts a Bluetooth high frequency signal of the first transmission output received from the Bluetooth antenna 550 to a digital signal and converts the digital signal to the Bluetooth high frequency signal.

The first duplexer 570 and the second duplexer 575 are connected to the Bluetooth antenna 550 to perform a function of dividing a transmission and reception frequency of the Bluetooth antenna 550, thereby protecting mixing of a signal. Further, the first duplexer 570 and the second duplexer 575 enable a signal having the first transmission output received through the Bluetooth antenna 550 to be input to the Bluetooth module 560.

The first output unit 580 outputs a signal having the first transmission output that is output from the Bluetooth module 560 to the power amplifier 400 of the case 20 of FIG. 2.

The first input unit 585 receives a signal having a second transmission output in which a signal having the first transmission output is amplified by the power amplifier 400 of the case 20 and outputs the signal to the Bluetooth antenna 550.

When the communication terminal 10 provides a Bluetooth function, transmission power of Bluetooth is generally divided into three classes, and this is shown in FIG. 6.

FIG. 18 is a table illustrating a class of transmission power of Bluetooth.

As shown in FIG. 18, transmission power of Bluetooth of the communication terminal 10 is divided into class 1, class 2, and class 3.

Class 1 has transmission power of 100 mW and a transmission output range of 100 m, and class 2 has transmission power of 2.5 mW and a transmission output range of 20 m to 30 m. Further, class 3 has transmission power of 1 mW and a transmission output range of 10 m. The classes 1 and 2 can set power control as an option, in the class 1, transmission power can be varied within a range of 1-100 mW and in the class 2, transmission power can be varied within a range of 0.25 to 2.5 mW.

Class 1 supports a function of ‘birdie-birdie’, ‘walkie-talkie’, ‘one phone’, ‘local area Internet’, etc., and classes 2 and 3 support a function of local area data transmission or wireless headset, etc.

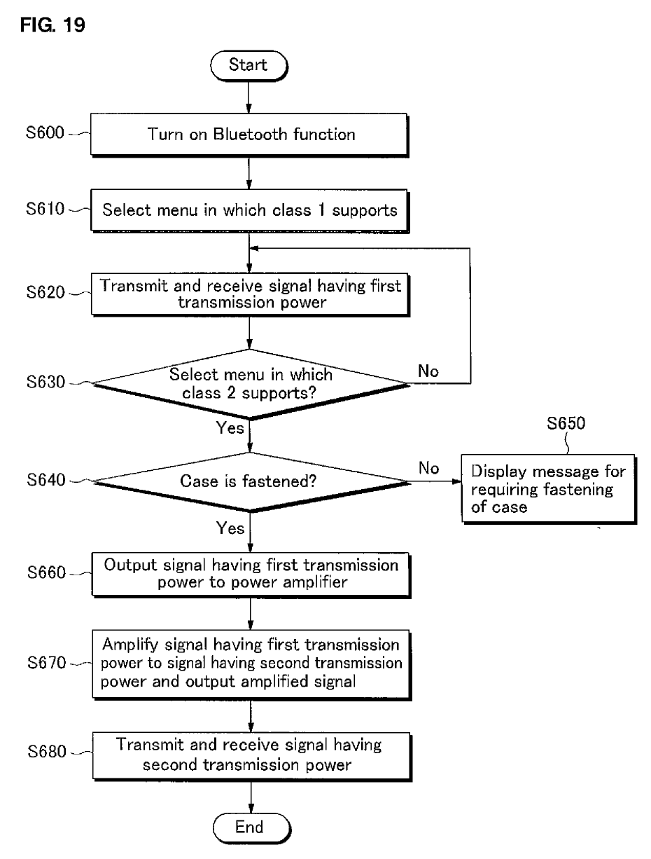

A method of amplifying power between classes of Bluetooth is shown in FIG. 19.

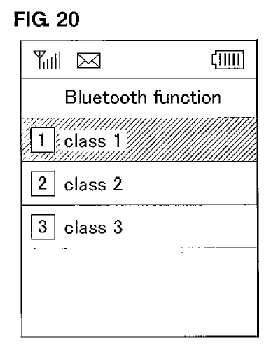

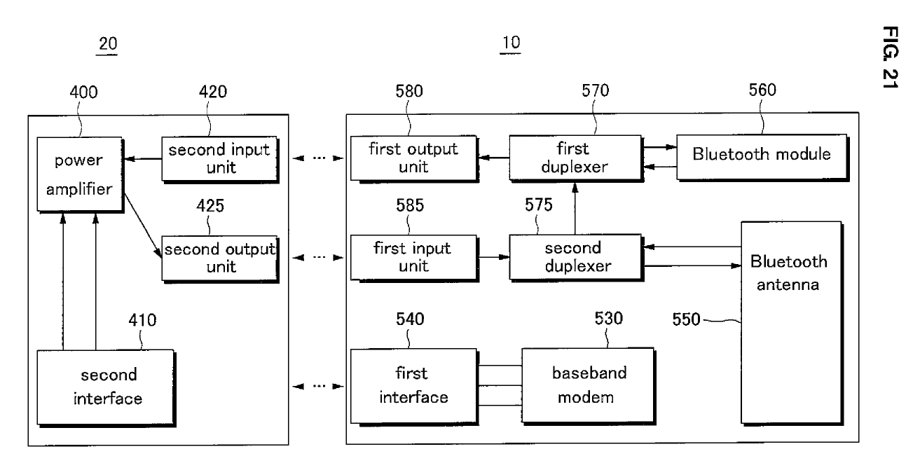

FIG. 19 is a flowchart illustrating a method of amplifying power of a communication terminal in an implementation. FIG. 20 is a diagram illustrating an example of selecting a class in an implementation. FIG. 21 is a block diagram illustrating an operation when a case and a communication terminal are coupled in an implementation.

As shown in FIG. 20, the controller 240 turns on a Bluetooth function by entering a Bluetooth menu (S600).

In this case, as described in FIG. 18, transmission power of Bluetooth is divided into three classes. When class 1 is selected (S610), a signal having 2.5 mV, which is the first transmission power received in the Bluetooth antenna 550 is received in a Bluetooth module 560 through the second duplexer 575 and the first duplexer 570 (S620).

Thereafter, after being converted to a signal in which Bluetooth can use in the Bluetooth module 560, the signal is output to the Bluetooth antenna 550 through the second duplexer 575 and the first duplexer 570.

The controller 240 checks whether class 2 is selected in a Bluetooth menu (S630).

If class 2 is selected in a Bluetooth menu, the baseband modem 530 checks whether the case 20 is fastened (S640).

If the case 20 is not fastened, the controller 240 controls to display a message for requiring fastening of the case 20 (S650).

If the case 20 is fastened, a signal having 2.5 mV, which is the first transmission power received in the Bluetooth antenna 550 can be amplified. As shown in FIG. 21, when the case 20 is fastened to the communication terminal 10, the first interface 500 of the communication terminal 10 is connected and fastened to the second interface 410 of the case 20. Further, the first input/output units (510, 515) of the communication terminal 10 are connected and fastened to the second input/output units (420, 425) of the case 20.

When the communication terminal 10 and the case 20 are fastened, a fastening signal is generated from the second interface 410 of the case 20 and output to the first interface 500.

This fastening signal is output to the baseband modem 530, thereby notifying that the communication terminal 10 and the case 20 are fastened.

When it is checked that the communication terminal 10 and the case 20 are fastened, the baseband modem 530 outputs a signal for turning on the power amplifier 400 of the case 20 to the power amplifier 400 through the first interface 500 and the second interface 410.

Accordingly, the power amplifier 400 is turned on. In this case, when the Bluetooth module 560 does not support Bluetooth class 1, the baseband modem 530 outputs a control signal for adjusting a gain value of the power amplifier 400 to the power amplifier 400 through the first interface 500 and the second interface 410.

Thereafter, a signal having 2.5 mV, which is the first transmission power received in the Bluetooth antenna 550 is output through the first duplexer 570 and the first output unit 580 (S660). In this case, a signal having the first transmission power is input to the power amplifier 400 through the second input unit 420 of the case 20 connected to the first output unit 580.

The signal is amplified to a signal having 100 m W, which is the second transmission power in the power amplifier 400 and is output to the first input unit 585 connected to the second output unit 425 (S670).

A signal having 100 m W, which is the amplified second transmission power is output to the Bluetooth antenna 550 via the second duplexer 575 and converts transmission power from class 2 to class 1 (S680).

In the communication terminal 10, class 2 can be easily converted to class 1 by amplifying transmission power of Bluetooth.

However, this document is not limited thereto and in the communication terminal 10, class 3 may be converted to class 1 or 2, when the baseband modem 530 sets a gain value of the power amplifier 400 and the power amplifier 400 amplifies received power to a corresponding gain value.

Further, in the above-described implementations, only amplifying of transmission power of Bluetooth is described, however this document is not limited thereto.

That is, this document may be applied to amplifying of a wireless signal received in the communication terminal 10 for receiving the wireless signal. Therefore, in this case, the respective elements can be changed according to a kind of received wireless signals.

Further, in the above-described implementations, each of the first input/output units (480, 485) and the second input/output units (420, 425) has two terminals, however this document is not limited thereto. That is, each of the first input/output units (480, 485) and the second input/output units (420, 425) may have one terminal and may have the quantity more than one terminal according to the input/output signal.

Further, the first interface 540 and the second interface 410 may have several terminals to correspond to a control signal.

Further, the case 20 in which the power amplifier 400 is formed is made of materials such as plastic as well as leather and is detachably formed to protect a housing of the communication terminal 10.

The case 20 has a structure for covering all or some of the communication terminal 10 and adjusts a position of the second interface 410 and the second input/output units (420, 425) according to a shape thereof.

As described above, this document has the following effect.

First, by coupling a case for the communication terminal having an extension device for extending a communication performance to the communication terminal, a communication performance of the communication terminal can be extended.

Second, by providing the extension device for extending a communication performance of the communication terminal in the case for the communication terminal, a performance of the communication terminal can be extended while decreasing a size thereof.

Other features will be apparent from the description and drawings, and from the claims.

What is claimed is:

1. A case for a communication terminal comprising:
a coupling unit configured to electrically couple the communication terminal and the case; and
an extension device formed in the case and configured to extend a communication performance of the communication terminal when the communication terminal and the case are coupled together via the coupling unit.

2. The case of claim 1, wherein the extension device comprises an operating antenna having a specific frequency band and that is connected to a Radio Frequency (RF) module in the communication terminal when the communication terminal and the case are coupled together via the coupling unit.

3. The case of claim 1, wherein the extension device comprises an operating power amplifier configured to amplify a transmission output of the communication terminal that is connected to a Radio Frequency (RF) module in the communication terminal when the communication terminal and the case are coupled together via the coupling unit.

4. The case of claim 1, wherein the coupling unit includes a pogo pin.

5. A communication terminal, comprising:
a communication module configured to wirelessly communicate with at least one other terminal;
a case configured to cover at least a portion of the communication terminal;
a coupling unit configured to electrically couple the communication terminal and the case; and
an extension device formed in the case and configured to extend a communication performance of the communication terminal when the communication terminal and the case are coupled together via the coupling unit.

6. The communication terminal of claim 5, wherein the coupling unit comprises:
a first connector formed in the case; and
a second connector formed in the communication terminal configured to electrically connect to the first connector when the communication terminal and the case are coupled together.

7. The communication terminal of claim 6, wherein the extension device comprises at least one operating antenna having a specific frequency band.

8. The communication terminal of claim 7, further comprising:
at least one internal antenna;
at least one (Radio Frequency) RF transceiver configured to selectively control the at least one internal antenna and the at least one operating antenna in the case;
a switching unit configured to selectively connect the at least one internal antenna to the RF transceiver or the at least one operating antenna in the case to the RF transceiver; and
a controller configured to control the switch to switch to a first position such that the at least one operating antenna in the case is connected to the RF transceiver and to switch to a second position such that the at least one internal antenna in the communication terminal is connected to the RF transceiver.

9. The communication terminal of claim 8, wherein the second connector outputs a connection signal to the controller when the second connector is connected to the first connector.

10. The communication terminal of claim 8, wherein the controller is further configured to check a Received Signal Strength Indicator (RSSI) of the at least one operating antenna in the case when the second connector is connected to the first connector and the switch is switched to the first position, and configured to check an RSSI of the at least one internal antenna when the switch is switched to the second position.

11. The communication terminal of claim 10, wherein the controller is further configured to compare the RSSIs of the at least one internal antenna and the at least one operating antenna in the case, and to switch the switch to the first or second positions such that the at least one internal antenna or the at least one operating antenna in the case having a highest RSSI is connected to the RF transceiver.

12. The communication terminal of claim 8, wherein the extension device comprises at least one operating power amplifier configured to amplify a power of an input signal.

13. The communication terminal of claim 12, wherein the coupling unit comprises:
first input and output units formed in the communication terminal and configured to input and output signals to and from the communication terminal, respectively;
second input and output units formed in the case and configured to input and output signals to and from the case, respectively;
a first interface formed in the communication terminal; and
a second interface formed in the communication terminal and configured to interface and communicate with the first interface formed in the communication terminal.

14. The communication terminal of claim 13, wherein the first input and output units and the first interface connect to the second input and output units and the second interface, respectively, when the case is coupled to the communication terminal.

15. The communication terminal of claim 13, wherein the second interface formed in the case is configured to receive a control signal from the controller in the communication terminal via the first interface and input the control signal to the power amplifier, and to output a connection signal to the controller in the communication terminal via the first interface when the case is coupled to the communication terminal via the coupling unit, and
wherein the second input unit formed in the case is configured to receive a first signal having a first transmission power via the first input unit, and the second output unit formed in the case is configured to output a second signal having an second transmission power amplified by the power amplifier according to the control signal from the second interface.

16. The communication terminal of claim 15, further comprising:
a first duplexer connected between the RF transceiver and the first output unit; and
a second duplexer connected between the at least one internal antenna and the first input unit and being connected to the first duplexer,
wherein the first signal is received through the at least one internal antenna, is input to the RF transceiver through the first and second duplexers, is output from the RF transceiver to the first output unit and then output to the second output unit formed in the case via the first output unit, and
wherein the first signal received in the second output unit formed in the case is amplified by the power amplifier based on the control signal into the second signal and is output by the second output unit in the case to the first input unit in the communication terminal and then is output to the at least one internal antenna via the second duplexer connected between the first input unit and the at least one internal antenna.

17. The communication terminal of claim 16, wherein the first signal is a Bluetooth signal in a first Bluetooth class having the first transmission power and the second signal is a Bluetooth signal in a second Bluetooth class having the second transmission power.

18. A method of communicating on a mobile terminal, the method comprising:
coupling a case to the mobile terminal such that the case and the mobile terminal are electrically coupled together; and
transmitting a signal from the mobile terminal that has been received or amplified by an extension communication device formed in the case.

19. The method of claim 18, wherein the extension communication device comprises at least one operating antenna having a specific frequency band or a power amplifier.

20. The method of claim 19, further comprising:
providing a menu option allowing a user to select a class transmission power from among a plurality of class transmission powers; and
amplifying a signal to be output via an internal antenna in the mobile terminal using the amplifier formed in the case to have the class transmission power selected by the user from the menu option.

21. The method of claim 20, wherein the plurality of class transmission powers corresponds to different class transmission powers used in short distance communications.

22. The method of claim 18, wherein the case and the mobile terminal are electrically coupled together via a coupling unit including a first connector formed in the case, and a second connector formed in the communication terminal configured to electrically connect to the first connector when the communication terminal and the case are coupled together.
